(19) United States
(12) Patent Application Publication
(10) Pub. No.: US 2016/0246317 A1
(43) Pub. Date: Aug. 25, 2016

(54) POWER AND AREA EFFICIENT METHOD FOR GENERATING A BIAS REFERENCE

(71) Applicant: QUALCOMM Incorporated, San Diego, CA (US)

(72) Inventors: Yu Song, San Diego, CA (US); Dinesh Jagannath Alladi, San Diego, CA (US); Dan Yuan, San Diego, CA (US)

(21) Appl. No.: 14/630,481

(22) Filed: Feb. 24, 2015

(51) Int. Cl. G05F 1/575

(52) U.S. Cl. CPC G05F 1/575

(57) ABSTRACT

In one embodiment, a method for generating a reference comprises generating a current that is approximately temperature independent over a temperature range based on an emitter-base voltage of a first bipolar junction transistor (BJT), and generating a first proportional to absolute temperature (PTAT) current based on the emitter-base voltage of the first BJT.

### BACKGROUND

1. Field

Aspects of the present disclosure relate generally to methods for generating a reference voltage and/or current, and more particularly, to a power and area efficient method for generating a reference voltage and/or current.

2. Background

Proportional to absolute temperature (PTAT) voltages and/or currents may be used in integrated circuits for various applications. For example, a PTAT voltage or current may be used to bias an amplifier to compensate for performance variation of the amplifier due to temperature. In another example, a PTAT current or voltage may be used in a temperature sensor to sense temperature in an integrated circuit.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a combined band-gap and proportional to absolute temperature (PTAT) circuit is provided herein. The combined circuit comprises a first bipolar junction transistor (BJT), and a feedback circuit configured to force a first voltage at a first node to be approximately equal to an emitter-base voltage of the first BJT, and to force a second voltage at a second node to be approximately equal to the emitter-base voltage of the first BJT. The combined circuit further comprises a first circuit coupled to the first node, wherein the first circuit is configured to generate a current that is approximately independent of temperature over a temperature range, and a second circuit coupled to the second node, wherein the second circuit is configured to generate a PTAT current.

A second aspect relates to a method for generating a reference. The method comprises generating a current that is approximately temperature independent over a temperature range based on an emitter-base voltage of a first bipolar junction transistor (BJT), and generating a first proportional to absolute temperature (PTAT) current based on the emitter-base voltage of the first BJT.

A third aspect relates to an apparatus for generating a reference. The apparatus comprises means for generating a current that is approximately temperature independent over a temperature range based on an emitter-base voltage of a first bipolar junction transistor (BJT), and means for generating a first proportional to absolute temperature (PTAT) current based on the emitter-base voltage of the first BJT.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows an example of a circuit for generating a proportional to absolute temperature (PTAT) reference.

FIG. 2 shows an example of a band-gap circuit for generating a current that is approximately temperature independent over a temperature range.

FIG. 3 shows a combined band-gap and PTAT circuit according to an embodiment of the present disclosure.

FIG. 4 shows a combined band-gap and PTAT circuit according to another embodiment of the present disclosure.

FIG. 5 shows a switched-capacitor resistor and a voltage regulator coupled to the combined circuit according to an embodiment of the present disclosure.

FIG. 6 shows an exemplary implementation of the switched-capacitor resistor according to an embodiment of the present disclosure.

FIG. 7 shows an example in which the combined circuit is used to generate a bias current for an operational transconductance amplifier (OTA) according to an embodiment of the present disclosure.

FIG. 8 is a flowchart showing a method for generating a reference according to an embodiment of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Proportional to absolute temperature (PTAT) voltages and/or currents may be used in integrated circuits for various applications. For example, a PTAT current may be used to bias an operational transconductance amplifier (OTA) to reduce variation in the transconductance of the OTA over temperature. The PTAT current does this by varying proportionately over temperature to compensate for changes in the carrier mobility of transistors in the OTA over temperature. In another example, a PTAT current or voltage may be used in a temperature sensor to sense temperature in an integrated circuit.

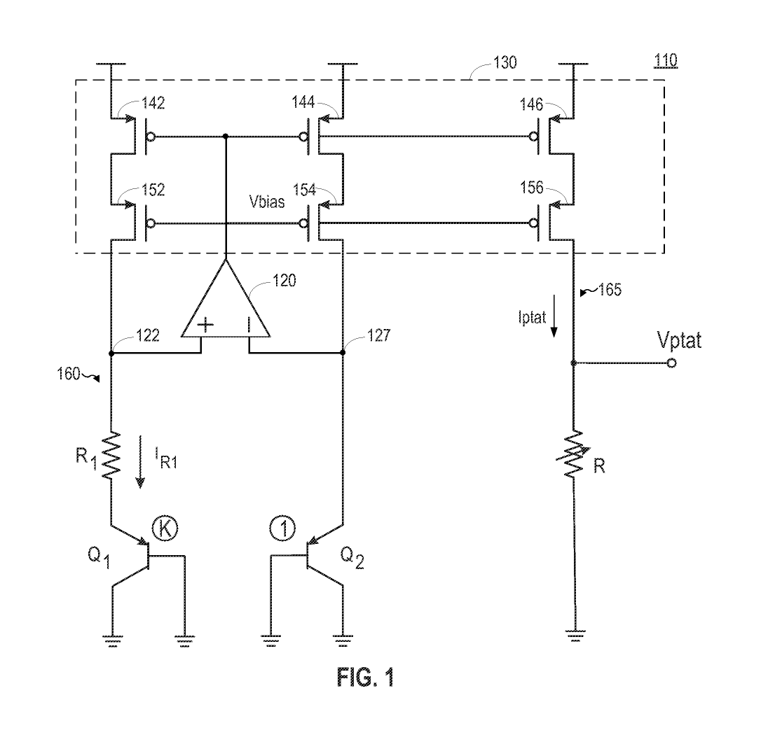

FIG. 1 shows an example of a PTAT circuit 110 for generating a PTAT voltage (denoted “Vptat”). The circuit 110 comprises a first bipolar junction transistor Q₁ and a second bipolar junction transistor Q₂, in which the first transistor Q₁ has an emitter area that is K times larger than the emitter area of the second transistor Q₂. Each of the transistors Q₁ and Q₂ may be diode-connected with the base of the transistor coupled to the respective collector. In the example in FIG. 1, the bases and collectors of the transistors Q₁ and Q₂ are coupled to ground.

The PTAT circuit 110 also comprises an operational amplifier 120, a resistor R₁, and a cascode current mirror 130. The emitter of the second transistor Q₂ is coupled to the inverting input (−) of the operational amplifier 120 at node 127. The resistor R₁ is coupled between the emitter of the first transistor Q₁ and the non-inverting input (+) of the operational amplifier 120 at node 122.

The cascode current mirror 130 comprises p-type metal-oxide-semiconductor (PMOS) transistors 142, 144, 146, 152, 154 and 156. The source of each of PMOS transistors 142, 144 and 146 is coupled to an upper power-supply rail, and the gate of each of PMOS transistors 142, 144 and 146 is biased by the output of the operational amplifier 120. The source of each of PMOS transistors 152, 154 and 156 is coupled to the drain of a respective one of PMOS transistors 142, 144 and 146, as shown in FIG. 1. The gate of each of PMOS transistors 152, 154 and 156 is biased by a DC voltage (denoted “Vbias”). The drain of PMOS transistor 152 is coupled to node 122, the drain of PMOS transistor 154 is coupled to node 127, and the drain of PMOS transistor 156 is coupled to current branch 165. As shown in FIG. 1, each of PMOS transistors 142, 144 and 146 is stacked with a respective one of PMOS transistors 152, 154 and 156. This increases the current matching performance of the cascade current mirror 130.

In operation, PMOS transistors 142, 144, 152 and 154 provide feedback paths between the output of the operational amplifier 120 and the inputs of the operational amplifier 120. The feedback paths cause the operational amplifier 120 to adjust its output voltage (which biases the gates of PMOS transistors 142 and 144) in a direction that reduces the difference between the voltages at its inputs. As a result, the operational amplifier 120 forces the voltages at its inputs (and hence the voltages at nodes 122 and 127) to be approximately equal.

Since the voltage at node 127 is approximately equal to the base-emitter voltage Vbe2 of the second transistor Q₂, the operational amplifier 120 forces the voltage at node 122 to be approximately equal to Vbe2. As a result, the voltage across the resistor R₁ is equal to the difference between the base-emitter voltage Vbe2 of the second transistor Q₂ and the base-emitter voltage Vbe1 of the first transistor Q₁ (denoted “ΔVbe_{2,1}”). The voltage difference ΔVbe_{2,1} is given by:

ΔVbe_{2,1}=Vt·ln(K) (1)

where Vt is the thermal voltage, and K is the emitter-area ratio between the first and second transistors Q₁ and Q₂. The thermal voltage Vt is proportional to absolute temperature, and approximately equal to 25 mV at room temperature (300 K). Thus, the voltage difference ΔVbe_{2,1} is also proportional to absolute temperature. The current through the resistor R₁ is equal to:

I_{R1}=ΔVbe_{2,1}/R₁ (2)

where R₁ in equation (2) is the resistance of the resistor R₁. Since the voltage difference ΔVbe_{2,1} is proportional to absolute temperature, the current I_{R1} flowing through the resistor R₁ is also proportional to absolute temperature. This current flows through current branch 160, as shown in FIG. 1.

The current mirror 130 mirrors the current I_{R1} in current branch 160 to current branch 165. The mirrored current in current branch 165 may be approximately equal to the current I_{R1} in current branch 160 multiplied by a scaling factor, where the scaling factor may be approximately equal to a ratio of the channel width of PMOS transistor 146 over the channel width of PMOS transistor 142. Since the current I_{R1} flowing through the resistor R₁ is proportional to absolute temperature, the mirrored current in current branch 165 is also proportional to absolute temperature. In FIG. 1, the mirrored current is denoted “Iptat” to indicate that the current is proportional to absolute temperature. The current Iptat flows through a resistor R in current branch 165, producing a voltage across the resistor R that is proportional to absolute temperature. This voltage provides the PTAT voltage Vptat, discussed above. In one example, the resistor R may have an adjustable (tunable) resistance, as shown in FIG. 1. In this example, the resistance of the resistor R may be adjusted to achieve a desired slope for the PTAT voltage Vptat over temperature.

Band-gap circuits are commonly used in integrated circuits to provide temperature-independent reference voltages and/or currents. For example, a band-gap circuit may be used to provide a bias voltage or current to an amplifier, an oscillator, or other type of analog circuit, in which the bias voltage or current is approximately constant over a desired temperature range.

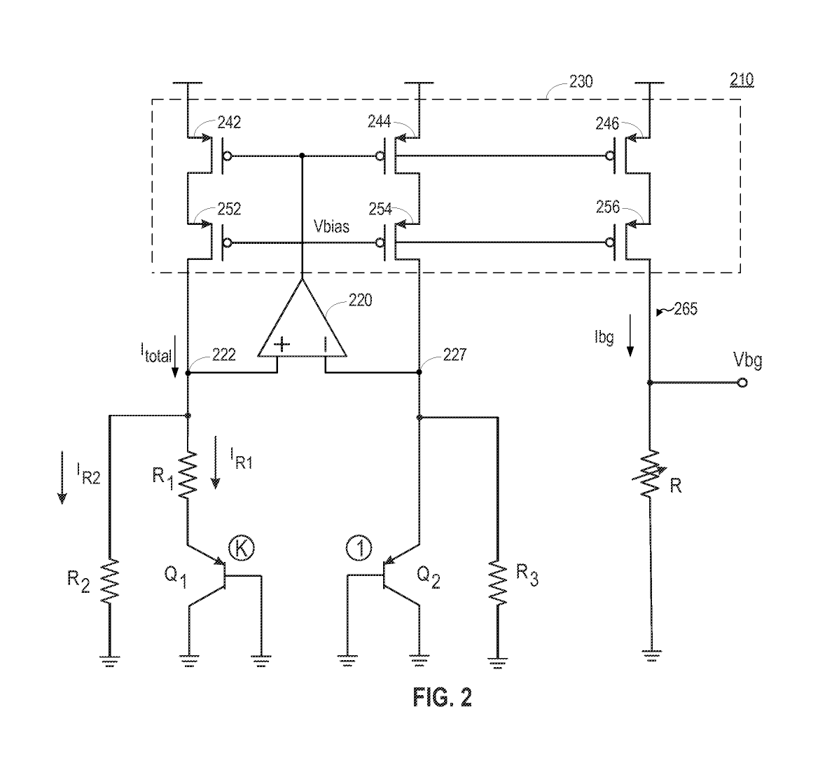

FIG. 2 shows an example of a band-gap circuit 210 configured to generate a voltage (denote “Vbg”) that is approximately independent of temperature over a desired temperature range (e.g., range spanning 50 K or more). The band-gap circuit 210 comprises a first bipolar-junction transistor Q₁ and a second bipolar-junction transistor Q₂, in which the first transistor Q₁ has an emitter area that is K times larger than the emitter area of the second transistor Q₂. Each of the transistors Q₁ and Q₂ may be diode-connected with the base of the transistor coupled to the respective collector. In the example in FIG. 2, the bases and collectors of the transistors Q₁ and Q₂ are coupled to ground.

The band-gap circuit 210 also comprises an operational amplifier 220, a cascode current mirror 230, and resistors R₁, R₂ and R₃. The emitter of the second transistor Q₂ is coupled to the inverting input (−) of the operational amplifier 220 at node 227. Resistor R₁ is coupled between the emitter of the first transistor Q₁ and the non-inverting input of the operational amplifier 220 at node 222. Resistor R₂ is coupled between node 222 and ground, and resistor R₃ is coupled between node 227 and ground. Resistors R₂ and R₃ may have equal resistances. As shown in FIG. 2, the band-gap circuit 210 is similar to the PTAT circuit 110 discussed above with the addition of resistors R₂ and R₃.

The cascode current mirror 230 comprises PMOS transistors 242, 244, 246, 252, 254 and 256. The source of each of PMOS transistors 242, 244 and 246 is coupled to an upper power-supply rail, and the gate of each of PMOS transistors 242, 244 and 246 is biased by the output of the operational amplifier 220. The source of each of PMOS transistors 252, 254 and 256 is coupled to the drain of a respective one of PMOS transistors 242, 244 and 246, as shown in FIG. 2. The gate of each of PMOS transistors 252, 254 and 256 is biased by a DC voltage (denoted “Vbias”). The drain of PMOS transistor 252 is coupled to node 222, the drain of PMOS transistor 254 is coupled to node 227, and the drain of PMOS transistor 256 is coupled to current branch 265.

In operation, PMOS transistors 242, 244, 252 and 254 provide feedback paths between the output of the operational amplifier 220 and the inputs of the operational amplifier 220. The feedback paths cause the operational amplifier 220 to adjust its output voltage (which biases the gates of PMOS transistors 242 and 244) in a direction that reduces the difference between the voltages at its inputs. As a result, the operational amplifier 220 forces the voltages at its inputs (and hence the voltages at nodes 222 and 227) to be approximately equal.

Since the voltage at node 227 is approximately equal to the base-emitter voltage Vbe2 of the second transistor Q₂, the operational amplifier 220 forces the voltage at node 222 to be approximately equal to Vbe2. As a result, the voltage across each of resistors R₂ and R₃ is approximately equal to the base-emitter voltage Vbe2 of the second transistor Q₂. The base-emitter voltage Vbe2 is approximately inversely proportional to absolute temperature. As a result, the current flowing through resistor R₂ (denoted “I_{R2}”) is a complementary to absolute temperature (CTAT) current (i.e., a current that is inversely proportional to absolute temperature). The voltage across resistor R₁ is equal to the difference between the base-emitter voltage Vbe2 of the second transistor Q₂ and the base-emitter voltage Vbe1 of the first transistor Q₁ (denoted “ΔVbe_{2,1}”). As discussed above, the voltage difference ΔVbe_{2,1} across resistor R₁ is proportional to absolute temperature, causing a PTAT current to flow through resistor R₁ (denoted “I_{R1}”).

The CTAT current I_{R2} flowing through resistor R₂ and the PTAT current I_{R1} flowing through resistor R₁ change in opposite directions over temperature. The total current flowing into node 222 (denoted “Iₜₒₜₐₗ”) is approximately equal to the sum of the CTAT current I_{R2} and the PTAT current I_{R1}. The resistances of resistors R₁ and R₂ can be selected such that changes in the CTAT current I_{R2} over temperature approximately cancel out changes in the PTAT current I_{R1} over temperature. As a result, the total current Iₜₒₜₐₗ (which is the sum of the CTAT current I_{R2} and the PTAT current I_{R1}) may be approximately temperature independent (i.e., approximately constant) over a temperature range.

The current mirror 230 mirrors the total current Iₜₒₜₐₗ to current branch 265. Since the total current Iₜₒₜₐₗ is approximately temperature independent, the mirrored current in current branch 265 (denoted “Ibg”) is also approximately temperature independent. The current Ibg flows through a resistor R in current branch 265, producing a voltage across the resistor R that is approximately temperature independent. This voltage provides the band-gap voltage Vbg, discussed above. In one example, the resistor R may have an adjustable (tunable) resistance, as shown in FIG. 2. In this example, the resistance of the resistor R may be adjusted to adjust the voltage level of the band-gap voltage Vbg.

An integrated circuit may include both PTAT circuits and band-gap circuits. Therefore, it may be desirable to combine a PTAT circuit and a band-gap circuit to reduce the number of components in the integrated circuit by allowing the PTAT circuit and band-gap circuit to share components.

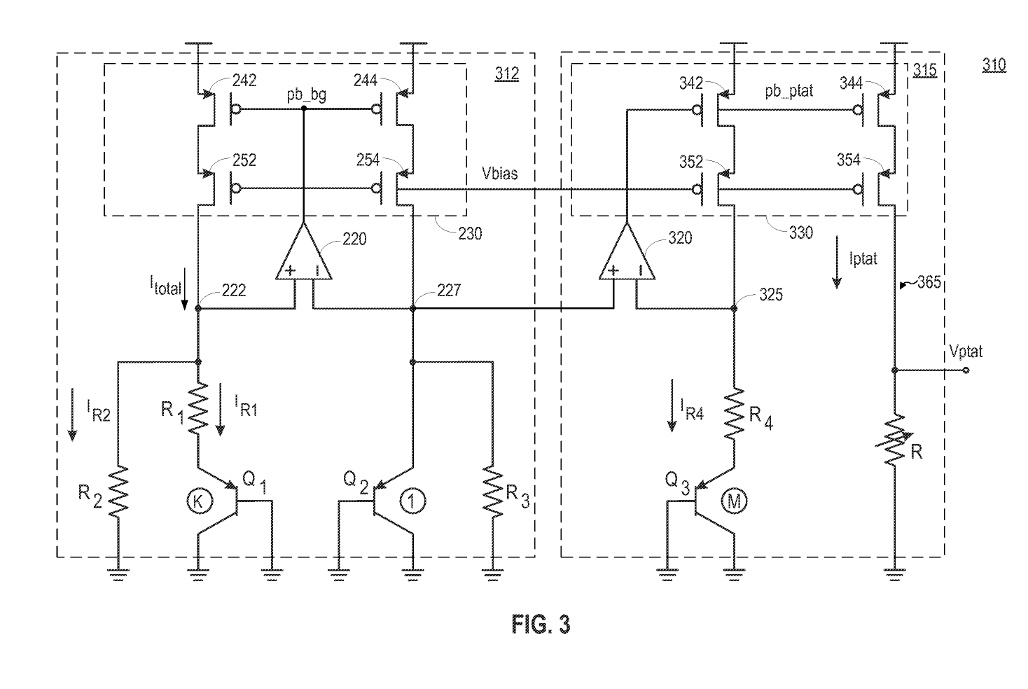

FIG. 3 shows a combined band-gap and PTAT circuit 310 according to an embodiment of the present disclosure. The combined circuit 310 comprises a band-gap circuit 312, and a PTAT circuit 315. The PTAT circuit 315 shares components with the band-gap circuit 312, allowing the PTAT circuit 315 to be implemented with fewer components compared to the stand-alone PTAT circuit 110 in FIG. 1, as discussed further below.

In the example in FIG. 3, the band-gap circuit 312 is similar to the band-gap circuit 210 shown in FIG. 2. The band-gap circuit 312 comprises a first bipolar-junction transistor Q₁ and a second bipolar-junction transistor Q₂, in which the first transistor Q₁ has an emitter area that is K times larger than the emitter area of the second transistor Q₂. Each of the transistors Q₁ and Q₂ may be diode-connected with the base of the transistor coupled to the respective collector. In the example in FIG. 3 the bases and collectors of the transistors Q₁ and Q₂ are coupled to ground.

The band-gap circuit 312 also comprises a first operational amplifier 220, a first cascode current mirror 230, and resistors R₁, R₂ and R₃. The emitter of the second transistor Q₂ is coupled to the inverting input (−) of the first operational amplifier 220 at node 227. Resistor R₁ is coupled between the emitter of the first transistor Q₁ and the non-inverting input (+) of the first operational amplifier 220 at node 222. Resistor R₂ is coupled between node 222 and ground, and resistor R₃ is coupled between node 227 and ground. Resistors R₂ and R₃ may have equal resistances.

The first cascode current mirror 230 comprises PMOS transistors 242, 244, 252 and 254. The source of each of PMOS transistors 242 and 244 is coupled to an upper power-supply rail, and the gate of each of PMOS transistors 242 and 244 is biased by the output of the first operational amplifier 220 (denoted “pb_bg”). The source of each of PMOS transistors 252 and 254 is coupled to the drain of a respective one of the PMOS transistors 242 and 244, as shown in FIG. 3. The gate of each of PMOS transistors 252 and 254 is biased by a DC voltage (denoted “Vbias”). The drain of PMOS transistor 252 is coupled to node 222, the drain of PMOS transistor 254 is coupled to node 227.

In operation, PMOS transistors 242, 244, 252 and 254 provide feedback paths between the output of the first operational amplifier 220 and the inputs of the first operational amplifier 220. The feedback paths cause the first operational amplifier 220 to adjust its output voltage (which biases the gates of PMOS transistors 242 and 244) in a direction that reduces the difference between the voltages at its inputs. As a result, the first operational amplifier 220 forces the voltages at its inputs (and hence the voltages at nodes 222 and 227) to be approximately equal.

Since the voltage at node 227 is approximately equal to the base-emitter voltage Vbe2 of the second transistor Q₂, the operational amplifier 220 forces the voltage at node 222 to be approximately equal to Vbe2. As a result, the voltage across each of resistors R₂ and R₃ is approximately equal to the base-emitter voltage Vbe2 of the second transistor Q₂. As discussed above, this causes a CTAT current I_{R2} to flow through resistor R₂. The voltage across resistor R₁ is equal to the difference between the base-emitter voltage Vbe2 of the second transistor Q₂ and the base-emitter voltage Vbe1 of the first transistor Q₁ (denoted “ΔVbe_{2,1}”). As discussed above, this causes a PTAT current I_{R1} to flow through resistor R₁.

The resistances of resistors R₁ and R₂ can be selected such that changes in the CTAT current I_{R2} over temperature approximately cancel out changes in the PTAT current I_{R1} over temperature. This results in a total current Iₜₒₜₐₗ (which is the sum of the CTAT current I_{R2} and the PTAT current I_{R1}) that is approximately temperature independent (i.e., approximately constant) over a temperature range.

The current mirror 230 may include additional transistors (not shown in FIG. 3) that mirror the total current Iₜₒₜₐₗ to one or more circuits (e.g., amplifier, oscillator, etc.) requiring a reference current that is approximately temperature independent over a desired temperature range. The one or more circuits may be integrated on the same chip as the band-gap circuit 312. The current mirror 230 may also mirror the total current Iₜₒₜₐₗ to a current branch comprising a resistor to generate a voltage across the resistor that is approximately independent of temperature, an example of which is shown in FIG. 2.

The PTAT circuit 315 comprises a third bipolar-junction transistor Q₃, in which the base and collector of the third transistor Q₃ are coupled together. In the example in FIG. 3, the base and collector of the third transistor Q₃ are coupled to ground. The third bipolar-junction transistor Q₃ has an emitter area that is M times larger than the emitter area of the second transistor Q₂ of the band-gap circuit 312, where M may be different than or the same as the emitter-area ratio K between the first and second transistors Q₁ and Q₂. The PTAT circuit 315 also comprises a second cascade current mirror 330, a second operational amplifier 320, and resistor R₄. Resistor R₄ is coupled between the emitter of the third transistor Q₃ and the inverting input (−) of the second operational amplifier 320 at node 330. The non-inverting input (+) of the second operational amplifier 320 is coupled to node 227 of the band-gap circuit 312.

The second cascode current mirror 330 comprises PMOS transistors 342, 344, 352 and 354. The source of each of PMOS transistors 342 and 344 is coupled to an upper power-supply rail, and the gate of each of PMOS transistors 342 and 344 is biased by the output of the second operational amplifier 320 (denoted “pb_ptat”). The source of each of PMOS transistors 352 and 354 is coupled to the drain of a respective one of the PMOS transistors 342 and 344, as shown in FIG. 3. The gate of each of PMOS transistors 352 and 354 is biased by Vbias. The drain of PMOS transistor 352 is coupled to node 325, the drain of PMOS transistor 354 is coupled to current branch 365.

In operation, PMOS transistors 342 and 352 provide a negative feedback path between the output of the second operational amplifier 320 and the inverting input the of the second operational amplifier 320. The negative feedback cause the second operational amplifier 220 to adjust its output voltage (which biases the gate of PMOS transistor 342) in a direction that reduces the difference between the voltages at its inputs. As a result, the second operational amplifier 320 forces the voltage at node 325 to be approximately equal to the voltage at node 227 of the band-gap circuit 312.

Since the voltage at node 227 is approximately equal to the base-emitter voltage Vbe2 of the second transistor Q₂, the second operational amplifier 320 forces the voltage at node 325 to be approximately equal to Vbe2. As a result, the voltage across resistor R₄ in the PTAT circuit 315 is equal to the difference between the base-emitter voltage Vbe2 of the second transistor Q₂ and the base-emitter voltage Vbe3 of the third transistor Q₃ (denoted “ΔVbe_{2,3}”). The voltage difference ΔVbe_{2,3} may be given by:

ΔVbe_{2,3}=Vt·ln(M) (3)

where Vt is the thermal voltage, and M is the emitter-area ratio between the third and second transistors Q₃ and Q₂. As discussed above, the thermal voltage Vt is proportional to absolute temperature. Thus, the voltage difference ΔVbe_{2,3} is also proportional to absolute temperature. The current flowing through resistor R₄ is equal to:

I_{R4}=ΔVbe_{2,3}/R₄ (4)

where R₄ in equation (4) is the resistance of resistor R₄. Since the voltage difference ΔVbe_{2,3} is proportional to absolute temperature, the current I_{R4} flowing through resistor R₄ is also proportional to absolute temperature.

The second current mirror 330 mirrors this current I_{R4} to current branch 365, resulting in a PTAT current (denoted “Iptat”) flowing through current branch 365. The PTAT current Iptat may be approximately equal to current I_{R4} multiplied by a scaling factor, where the scaling factor may be approximately equal to a ratio of the channel width of PMOS transistor 344 over the channel width of PMOS transistor 342. The current Iptat flows through a resistor R in current branch 365, producing a voltage across the resistor R that is proportional to absolute temperature. This voltage provides the PTAT voltage Vptat, discussed above. In one example, the resistor R may have an adjustable (tunable) resistance, as shown in FIG. 3. In this example, the resistance of the resistor R may be adjusted to achieve a desired slope for the PTAT voltage Vptat over temperature.

In the example in FIG. 3, the PTAT circuit 315 shares the second transistor Q₂ with the band-gap circuit 312, thereby reducing the number of bipolar junction transistors in the PTAT circuit 315 compared to the stand-alone PTAT circuit 110 in FIG. 1. The third transistor Q₃ and resistor R₄ in the PTAT circuit 315 produce a PTAT current I_{R4} in a similar manner as the first transistor Q₁ and resistor R₁ in the band-gap circuit 312, which produce PTAT current I_{R1}. However, since a resistor is not coupled between node 325 and ground to produce a CTAT current, the PTAT current I_{R4} in the PTAT circuit 315 is not summed with a CTAT current to produce a temperature independent current.

In one embodiment, the PTAT current I_{R4} in the PTAT circuit 315 may be reduced to reduce the power consumption and area of the PTAT circuit 315. For example, the PTAT current I_{R4} in the PTAT circuit 315 may be made smaller than the PTAT current I_{R1} in the band-gap circuit 312 by a factor of N. In other words, the PTAT current I_{R4} in the PTAT circuit 315 may be related to the PTAT current I_{R1} in the band-gap circuit 312 by the following:

I_{R4}=I_{R1}/N (5)

where N may be greater than one. This may be accomplished, for example, by scaling the resistance of resistor R₄ relative to the resistance of resistor R₁ as follows:

$${R}_{4} = \frac{N * ln ( M * N )}{ln ( K )} * {R}_{1} \qquad ( 6 )$$

where R₁ in equation (6) is the resistance of resistor R₁, R₄ in equation (6) is the resistance of resistor R₄, M is the emitter-area ratio between the third and second transistors Q₃ and Q₂, and K is the emitter-area ratio between the first and second transistors Q₁ and Q₂. The emitter-area ratio M may be scaled down to reduce the area of the third transistor Q₃. This also reduces the resistance (and hence the area) of resistor R₄ for a given N and K, as shown in equation (6). Thus, the size of the third transistor Q₃ and/or size of resistor R₄ may be scaled to achieve good power and/or area efficiency.

The resistors R, R₁, R₂, R₃ and R₄ may be integrated on a chip using, for example, polysilicon resistors, metal resistors, etc. In this example, the resistances of the resistors vary from chip to chip due to process variation. However, sensitivity of the reference voltage Vref to process variation in resistance is reduced. This is because the reference voltage Vref is proportional to a ratio of the resistance of resistor R over the resistance of resistor R₄. As a result, process variation in the resistance of resistor R tends to cancel out process variation in the resistance of resistor R₄. This assumes that resistors R and R₄ are integrated on the same chip, and are therefore subject to approximately the same process conditions.

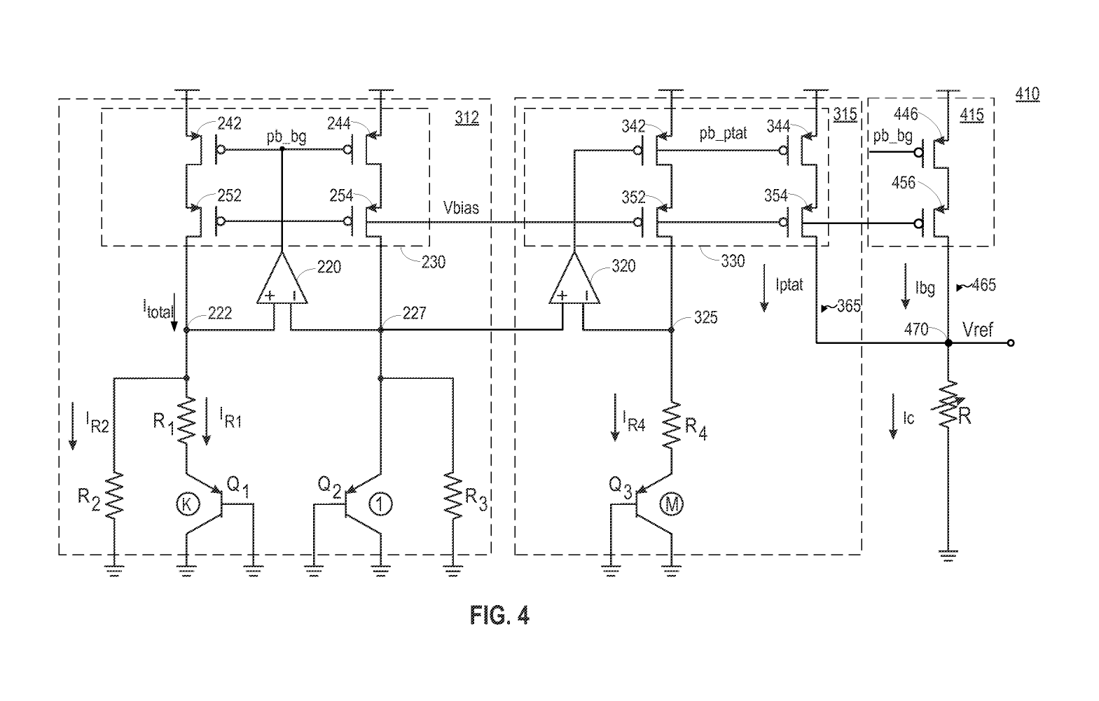

FIG. 4 shows a combined band-gap and PTAT circuit 410 according to another embodiment of the present disclosure. The combined circuit 410 is similar to the combined circuit 310 shown in FIG. 3, and further includes a band-gap current generation circuit 415. The current generation circuit 415 comprises PMOS transistors 446 and 456. The source of PMOS transistor 446 is coupled to the upper power-supply rail, and the gate of PMOS transistor 446 is coupled to the gates of PMOS transistors 242 and 244. For ease of illustration, the connection between the gate of PMOS transistor 446 and the gates of PMOS transistors 242 and 244 is not explicitly shown in FIG. 4. The source of PMOS transistor 456 is coupled to the drain of PMOS transistor 446, the gate of PMOS transistor 456 is biased by Vbias, and the drain of PMOS transistor 456 is coupled to current branch 465.

In operation, the first current mirror 230 and the current generation circuit 415 mirror the temperature-independent current Iₜₒₜₐₗ of the band-gap circuit 312 to current branch 465, resulting in a temperature-independent current (denoted “Ibg”) flowing through branch 465. In this respect, the first current mirror 230 and the current generation circuit 415 may collectively be considered a current mirror. The temperature-independent current Ibg may be approximately equal to current Iₜₒₜₐₗ multiplied by a scaling factor, where the scaling factor may be approximately equal to a ratio of the channel width of PMOS transistor 446 over the channel width of PMOS transistor 242. The temperature-independent current Ibg may be combined (summed) with PTAT current Iptat at node 470, and the resulting combined current (denoted “Ic”) may flow through resistor R to produce a reference voltage (denoted “Vref”).

The combined current Ic has a component that is approximately proportional to absolute temperature (i.e., Iptat) and a component that is approximately temperature independent over a temperature range (i.e., Ibg). As a result, the reference voltage Vref also has a component that is approximately proportional to absolute temperature (i.e., Iptat·R) and a component that is approximately temperature independent over a temperature range (i.e., Ibg·R). The component that is proportional to absolute temperature causes the reference voltage Vref to change approximately linearly with temperature. The slope of the change may be adjusted, for example, by adjusting the resistance of resistor R and/or the channel width of PMOS transistor 344 relative to the channel width of PMOS transistor 342. The component that is approximately temperature independent provides a voltage offset to the reference voltage Vref. The voltage offset may be adjusted, for example, by adjusting the resistance of resistor R and/or the channel width of PMOS transistor 446 relative to the channel width of PMOS transistor 242.

Thus, one or both components of the reference voltage Vref may be adjusted so that the reference voltage Vref has a desired linear relationship with temperature. For example, the reference voltage Vref may be used to bias an amplifier to compensate for performance variation of the amplifier due to temperature. In this example, a voltage bias may be determined as a function of temperature, in which the voltage bias compensates for changes in performance of the amplifier due to temperature. After the function is determined, one or both components of the reference voltage Vref may be adjusted to provide a voltage bias that approximates the determined function over a temperature range of interest.

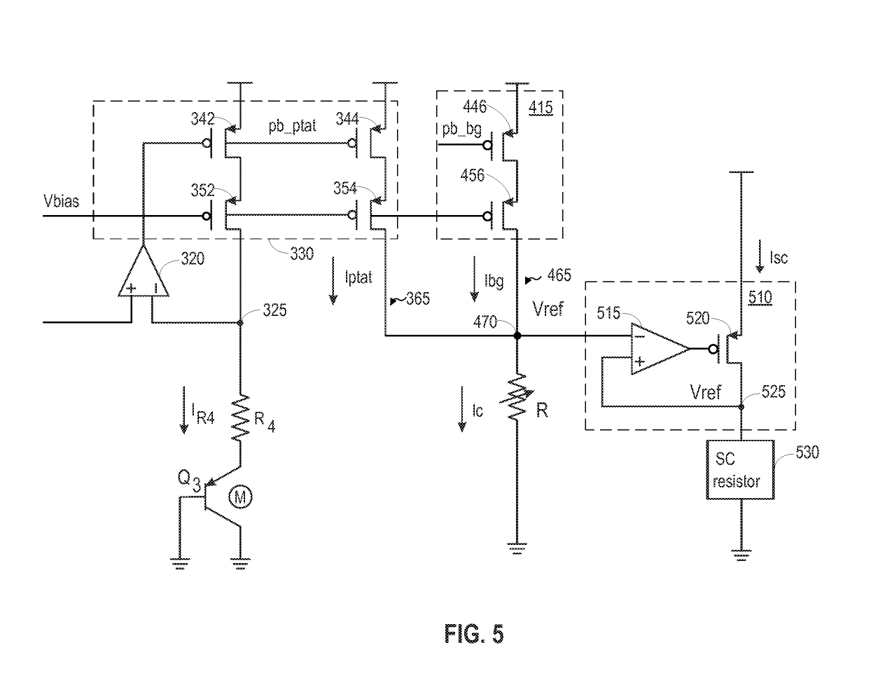

FIG. 5 shows an example in which the combined circuit 410 is used to generate a current (denoted “Isc”) that tracks process variation in capacitance. For ease of illustration, the band-gap circuit 312 is not shown in FIG. 5. In this example, the chip on which the combined circuit 410 is integrated may also comprise a voltage regulator 510 and a switched-capacitor resistor 530.

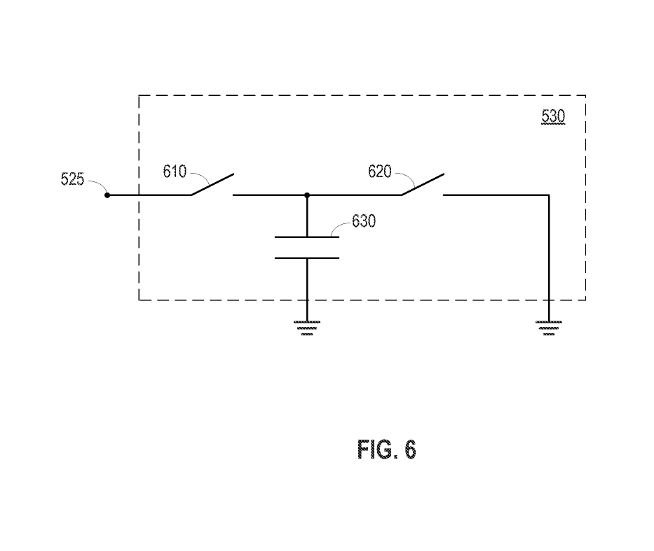

The switched-capacitor resistor 530 may comprise one or more capacitors and a plurality of switches that are switched by complementary clock signals. In this regard, FIG. 6 shows an exemplary implementation of the switched-capacitor resistor 530. In this example, the switched capacitor resistor 530 comprises a capacitor 630, a first switch 610, and a second switch 620. The first switch 610 is coupled between node 525 and a first terminal of the capacitor 630, and the second switch 620 is coupled between the first terminal of the capacitor 630 and ground. A second terminal of the capacitor 630 is coupled to ground. The first and second switches 610 and 620 may be controlled by complementary clock signals. In other words, the clock signal that switches the first switch 610 may be the complement of the clock signal that switches the second switch 620. In this example, the equivalent resistance of the switched-capacitor resistor 530 may be approximately equal to:

$${R}_{sc} = \frac{1}{f \cdot C} \qquad ( 7 )$$

where R_{sc} is the equivalent resistance of the switched-capacitor resistor 530, f is the frequency of the complementary clock signals, and C is the capacitance of the capacitor 630. It is to be appreciated that the switched-capacitor resistor 530 is not limited to the exemplary implementation shown in FIG. 6.

Referring back to FIG. 5, the voltage regulator 510 includes an operational amplifier 515 and PMOS transistor 520. The gate of PMOS transistor 520 is coupled to the output of the operational amplifier 515 and the drain of PMOS transistor 520 is coupled to a first input of the operational amplifier 515 in a feedback loop, as shown in FIG. 5. A second input of the operational amplifier 515 is coupled to the reference voltage Vref from the combined circuit 410. The switched-capacitor resistor 530 is coupled between the drain of PMOS transistor 520 at node 525 and ground.

In operation, the operational amplifier 515 adjusts the gate voltage of PMOS transistor 520 in a direction that reduces the difference between the voltage at node 525 (which is fed back to the first input of the operational amplifier 515) and the reference voltage Vref (which is input to the second input of the operation amplifier 515). Thus, the operational amplifier 515 forces the voltage at node 525 to be approximately equal to the reference voltage Vref, and therefore maintains a voltage at node 525 that is approximately equal to the reference voltage Vref.

The regulated voltage at node 525 (which is approximately equal to the reference voltage Vref) is applied across the switched-capacitor resistor 530. This produces a current Isc approximately equal to:

Isc=Vref/Rsc (8)

where Rsc is the equivalent resistance of the switched-capacitor resistor 530. The current Isc has a component that is proportional to absolute temperature. This is because the reference voltage Vref has a component that is proportional to absolute temperature, as discussed above. Therefore, the current Isc may be used to provide a bias current to an amplifier that changes proportionality with temperature to compensate for changes in performance of the amplifier due to temperature.

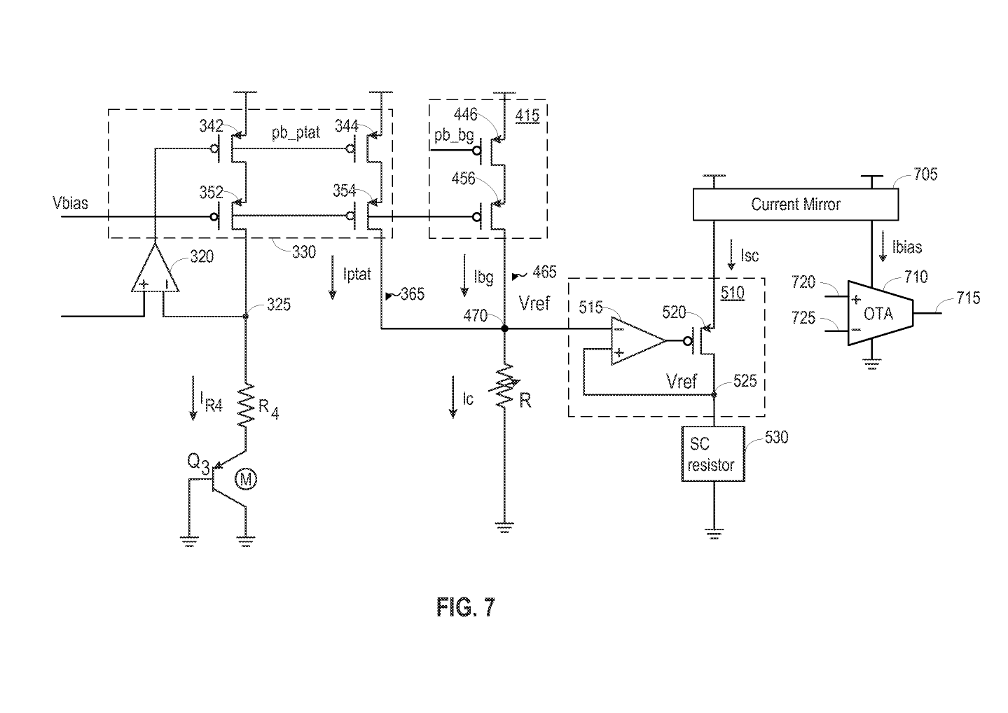

The current Isc tracks process variation in capacitance. This is because the equivalent resistance of the switched-capacitor resistor 530 is a function of the capacitance of one or more capacitors in the switched-capacitor resistor 530, and is therefore sensitive to process variation in capacitance. An application for tracking process variation in capacitance will now be described with reference FIG. 7.

FIG. 7 shows an example in which the current Isc is mirrored by current mirror 705 to provide a bias current Ibias for an operational transconductance amplifier (OTA) 710. Although FIG. 7 shows an example in which the current mirror 705 is coupled between the upper supply rail and the OTA 710, it is to be appreciated that the current mirror 705 may be coupled between the OTA 710 and ground.

The OTA 710 may be configured to convert a differential voltage at inputs 720 and 725 into a current at output 715, where the output current is approximately equal to the differential voltage times the transconductance of the OTA 710. In this example, the reference voltage Vref may be adjusted as discussed above so that the bias current Ibias compensates for changes in carrier mobility of transistors in the OTA 710 over temperature. This reduces variation in the transconductance of the OTA 710 over temperature, which reduces power consumption compared to using a constant bias.

In this example, the OTA 710 may drive a load capacitor (not shown) that is integrated on the same chip as the capacitor 630 of the switched-capacitor resistor 530. Since the load capacitor and the capacitor 630 of the switched-capacitor resistor 530 are integrated on the same chip, they are subject to approximately the same process conditions. As a result, the current Isc (which is a function of the capacitance of the capacitor in the switched-capacitor resistor 530) tracks process variation in the capacitance of the load capacitor. The current Isc is mirrored by current mirror 705 to provide the bias current Ibias for the OTA 710. Thus, the bias current Ibias also tracks process variation in the capacitance of the load capacitor, and therefore reduces the effect of the process variation in capacitance on the performance of the OTA 710.

It is to be appreciated that embodiments of the present disclosure are not limited to the exemplary implementations shown in the figures. For example, it is to be appreciated that the band-gap current generation circuit 415 in FIGS. 4, 5 and 7 may be omitted if a voltage offset is not needed for the reference voltage Vref to achieve a desired bias voltage or current. In another example, it is to be appreciated that non-cascode current mirrors may be used. In this example, PMOS transistors 252, 254, 352, 354 and 456 shown in FIGS. 3, 4, 5 and 7 may be omitted. In yet another example, it is to be appreciated that any one of a number of different feedback circuits may be used to force nodes 222 and 325 to be approximately equal to the emitter-base voltage Vbe2 of the second transistor Q₂. Accordingly, the present disclosure is not limited to the exemplary feedback circuit shown in FIG. 3 (i.e., the first and second operational amplifiers 220 and 320 coupled in the exemplary feedback configurations shown in FIG. 3).

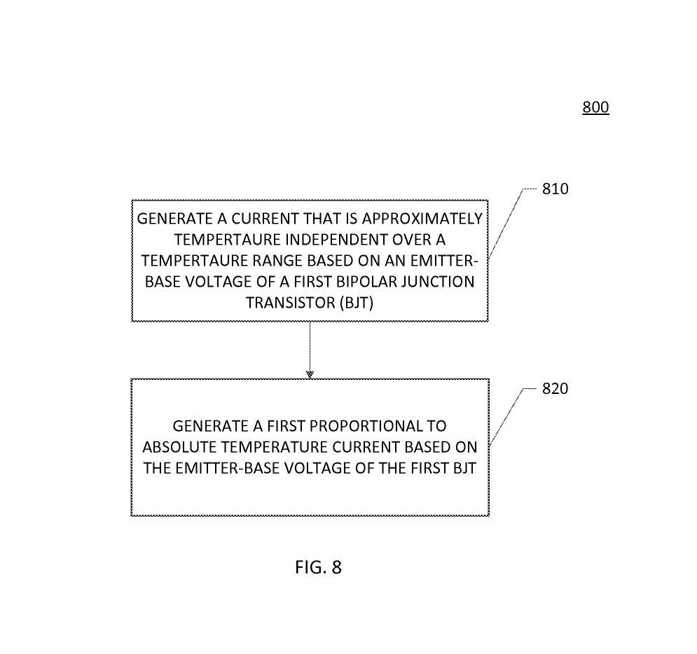

FIG. 8 is a flowchart showing a method 800 for generating a reference according to an embodiment of the present disclosure. The method 800 may be performed by the combined band-gap and PTAT circuit 310 or 410.

In step 810, a current that is approximately temperature independent over a temperature range is generated based an emitter-base voltage of a first bipolar junction transistor (BJT). For example, the temperature-independent current may be generated by applying a first voltage difference across a first resistor (e.g., R1) to generate a PTAT current (e.g., I_{R1}), wherein the first voltage difference is a difference between the emitter-base voltage of the first BJT (e.g., transistor Q₂) and an emitter-base voltage of a second BJT (e.g., transistor Q₁), and applying the emitter-base voltage of the first BJT across a second resistor (e.g., R₂) to generate a complementary to absolute temperature (CTAT) current (e.g., I_{R2}). In this example, changes in the CTAT current over the temperature range approximately cancels out changes in the PTAT current over the temperature range so that the sum of the CTAT and PTAT current produces the temperature-independent current.

In step 820, a first proportional to absolute temperature (PTAT) current is generated based on the emitter-base voltage of the first BJT. For example, the first PTAT current may be generated by applying a second voltage difference across a third resistor (e.g., R₄) to generate the first PTAT current, wherein the second voltage difference is a difference between the emitter-base voltage of the first BJT (e.g., transistor Q₂) and an emitter-base voltage of a third BJT (e.g., transistor Q₃).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A combined band-gap and proportional to absolute temperature (PTAT) circuit, comprising:
a first bipolar junction transistor (BJT);
a feedback circuit configured to force a first voltage at a first node to be approximately equal to an emitter-base voltage of the first BJT, and to force a second voltage at a second node to be approximately equal to the emitter-base voltage of the first BJT;
a first circuit coupled to the first node, wherein the first circuit is configured to generate a current that is approximately independent of temperature over a temperature range;
a second circuit coupled to the second node, wherein the second circuit is configured to generate a PTAT current.

2. The circuit of claim 1, wherein the first circuit comprises:
a second BJT having a base coupled to a ground;
a first resistor coupled between an emitter of the second BJT and the first node; and
a second resistor coupled between the first node and the ground.

3. The circuit of claim 2, wherein the second circuit comprises:
a third BJT having a base coupled to the ground;
a third resistor coupled between an emitter of the third BJT and the second node.

4. The circuit of claim 3, further comprising a fourth resistor coupled between the emitter of the first BJT and the ground.

5. The circuit of claim 2, wherein the second BJT has an emitter area that is larger than an emitter area of the first BJT.

6. The circuit of claim 1, further comprising:
a resistor; and
a first current mirror coupled to the resistor and the second circuit, wherein the current mirror is configured to mirror the PTAT current of the second circuit to generate a mirrored PTAT current, and to output the mirrored PTAT current to the resistor to generate a reference voltage across the resistor.

7. The circuit of claim 6, further comprising a voltage regulator having an input coupled to the resistor and an output, wherein the voltage regulator is configured to maintain a voltage at the output that is approximately equal to the reference voltage.

8. The circuit of claim 7, further comprising a switched-capacitor resistor coupled to the output of the voltage regulator, wherein the switched-capacitor resistor is configured to convert the voltage at the output of the voltage regulator into a switched-capacitor current.

9. The circuit of claim 8, further comprising a second current mirror configured to mirror the switched-capacitor current to generate a bias current, and to provide the bias current to an operational transconductance amplifier.

10. The circuit of claim 1, further comprising:
a resistor;
a first current mirror coupled to the second circuit and a third node, wherein the first current mirror is configured to mirror the PTAT current of the second circuit to generate a mirrored PTAT current; and
a second current mirror coupled to the first circuit and the third node, wherein the second current mirror is configured to mirror the current of the first circuit to generate a mirrored temperature-independent current;
wherein the mirrored PTAT current and the mirrored temperature-independent current are summed at the third node to obtain a combined current and the combined current is output to the resistor to generate a reference voltage across the resistor.

11. A method for generating a reference, comprising:
generating a current that is approximately temperature independent over a temperature range based on an emitter-base voltage of a first bipolar junction transistor (BJT); and
generating a first proportional to absolute temperature (PTAT) current based on the emitter-base voltage of the first BJT.

12. The method of claim 11, wherein generating the current that is approximately temperature independent comprises:
applying a first voltage difference across a first resistor to generate a second PTAT current, wherein the first voltage difference is a difference between the emitter-base voltage of the first BJT and an emitter-base voltage of a second BJT;
applying the emitter-base voltage of the first BJT across a second resistor to generate a complementary to absolute temperature (CTAT) current; and
summing the second PTAT current and the CTAT current to produce the temperature-independent current;
wherein changes in the CTAT current over the temperature range approximately cancels out changes in the second PTAT current over the temperature range.

13. The method of claim 12, wherein generating the first PTAT current comprises applying a second voltage difference across a third resistor to generate the first PTAT current, wherein the second voltage difference is a difference between the emitter-base voltage of the first BJT and an emitter-base voltage of a third BJT.

14. The method of claim 10, further comprising:
mirroring the first PTAT current using a current mirror to generate a mirrored PTAT current; and
outputting the mirrored PTAT current to a resistor to generate a reference voltage across the resistor.

15. The method of claim 14, further comprising converting the reference voltage into a bias current using a switched-capacitor resistor.

16. The method of claim 15, further comprising biasing an operational transconductance amplifier with the bias current.

17. The method of claim 11, further comprising:
mirroring the first PTAT current using a first current mirror to generate a mirrored PTAT current;
mirroring the temperature-independent current using a second current mirror to generate a mirrored temperature-independent current;
summing the mirrored PTAT current and the mirrored temperature-independent current to obtain a combined current; and
outputting the combined current to a resistor to generate a reference voltage across the resistor.

18. An apparatus for generating a reference, comprising:
means for generating a current that is approximately temperature independent over a temperature range based on an emitter-base voltage of a first bipolar junction transistor (BJT); and
means for generating a first proportional to absolute temperature (PTAT) current based on the emitter-base voltage of the first BJT.

19. The apparatus of claim 18, wherein the means for generating the current that is approximately temperature independent comprises:
means for applying a first voltage difference across a first resistor to generate a second PTAT current, wherein the first voltage difference is a difference between the emitter-base voltage of the first BJT and an emitter-base voltage of a second BJT;
means for applying the emitter-base voltage of the first BJT across a second resistor to generate a complementary to absolute temperature (CTAT) current; and
means for summing the second PTAT current and the CTAT current to produce the temperature-independent current;
wherein changes in the CTAT current over the temperature range approximately cancels out changes in the second PTAT current over the temperature range.

20. The apparatus of claim 19, wherein the means for generating the first PTAT current comprises applying a second voltage difference across a third resistor to generate the first PTAT current, wherein the second voltage difference is a difference between the emitter-base voltage of the first BJT and an emitter-base voltage of a third BJT.

21. The apparatus of claim 18, further comprising:
means for mirroring the first PTAT current using a current mirror to generate a mirrored PTAT current; and
means for outputting the mirrored PTAT current to a resistor to generate a reference voltage across the resistor.

22. The apparatus of claim 21, further comprising means for converting the reference voltage into a bias current using a switched-capacitor resistor.

23. The apparatus of claim 22, further comprising means for biasing an operational transconductance amplifier with the bias current.

24. The apparatus of claim 18, further comprising:
means for mirroring the first PTAT current using a first current mirror to generate a mirrored PTAT current;
means for mirroring the temperature-independent current using a second current mirror to generate a mirrored temperature-independent current;
means for summing the mirrored PTAT current and the mirrored temperature-independent current to obtain a combined current; and
means for outputting the combined current to a resistor to generate a reference voltage across the resistor.
